(19) United States
(12) Patent Application Publication
(10) Pub. No.: US 2025/0224009 A1
(43) Pub. Date: Jul. 10, 2025

(54) ELECTROMECHANICAL SPREADER DEVICE FOR A DRUM BRAKE

(71) Applicant: HELLA GmbH & Co. KGaA, Lippstadt (DE)

(72) Inventors: Joachim FUNKE, Otzberg (DE); Christian ISEKE, Paderborn (DE); Hagen MUELLER, Bad Wuennenberg (DE); Verena SUNDERMEIER, Dellbrueck (DE); Marco UNTERHALT, Salzkotten (DE)

(73) Assignee: HELLA GmbH & Co. KGaA, Lippstadt (DE)

(21) Appl. No.: 19/095,023

(22) Filed: Mar. 30, 2025

Related U.S. Application Data
(63) Continuation of application No. PCT/EP2023/074997, filed on Sep. 12, 2023.

(30) Foreign Application Priority Data
Sep. 29, 2022 (DE) 10 2022 125 136.5

(51) Int. Cl. F16D 65/22; F16D 121/24; F16D 125/30; F16D 125/40; F16D 125/52

(52) U.S. Cl. CPC F16D 65/22; F16D 2121/24; F16D 2125/30; F16D 2125/40; F16D 2125/52

(57) ABSTRACT

An electromechanical spreader device for a drum brake of a vehicle, comprising an electric motor with an output, a cam disc connected to the output so as to transmit torque and is arranged between two actuating elements for simultaneously actuating the two actuating elements during a braking action. The cam disc is connected to an actuating disc of a stepping gear so as to transmit torque. The stepping gear is connected to a second of the two actuating elements so as to transmit force, such that the second actuating element is adjustable via rotation of the cam disc in an engagement angle of rotation range, in which the actuating disc is in torque-transmitting engagement with a remaining part of the stepping gear, and is adjustable away from the brake shoe in the opposite direction in the engagement angle of rotation range via rotation of the cam disc.

This nonprovisional application is a continuation of International Application No. PCT/EP2023/074997, which was filed on Sep. 12, 2023, which claims priority to German Patent Application No. 10 2022 125 136.5, which was filed in Germany on Sep. 29, 2022, and which are both herein incorporated by reference.

### BACKGROUND OF THE INVENTION

### Field of the Invention

The present invention relates to an electromechanical spreader device for a drum brake.

### Description of the Background Art

Electromagnetic spreader devices of for drum brakes are already known from the prior art in numerous design variants and comprise an electric motor, which is controllable with the aid of a controller of the vehicle and includes an output, a cam disk which is connected to the output in a torque-transmitting manner and is arranged between two actuating elements situated opposite each other, each connected to one of the brake shoes in a force-transmitting manner, for simultaneously actuating the two actuating elements during a braking action of the spreader device, a first of the two actuating elements having a spring element arranged between an actuating plunger of this first actuating element, which contacts the cam disk in a force-transmitting manner, and an abutment of this first actuating element.

This is where the present invention comes in.

### SUMMARY OF THE INVENTION

It is therefore an object of the present invention to improve an electromechanical spreader device for a drum brake.

This object is achieved by an electromechanical spreader device for a drum brake, which is characterized in that the cam disk can be connected to an actuating disk of a stepping gear in a torque-transmitting manner, and the stepping gear is connected to a second of the two actuating elements in a force-transmitting manner in such a way that this second actuating element is adjustable via a rotation of the cam disk in an engagement rotation angle area, in which the actuating disk is in a torque-transmitting engagement with a remaining part of the stepping gear in a first direction of rotation toward the brake shoe, which is movable therewith, and is adjustable away from this brake shoe in the opposite direction in the engagement rotation angle area via a rotation of the cam disk in a second direction of rotation opposed to the first direction of rotation. The term “spring element” here is to be broadly interpreted and comprises all conceivable and suitable examples of a spring element, a plurality of springs of the spring element also being conceivable. Reference is made here only to spring packages or the like purely as examples. The same applies to the term “cam disk,” which may have any conceivable and suitable form of a cam for actuating an actuating plunger. The subclaims relate to advantageous refinements of the invention.

An essential advantage of the invention is, in particular, that an electromechanical spreader device for a drum brake is improved. Due to the design of the electromagnetic spreader device according to the invention, an electromotive spreader mechanism is specified, which combines the system-inherent advantages of a cam drive and a recirculating ball screw, thereby creating an electromechanical spreader element which, using only one electromotive drive, facilitates a system brake, i.e. carrying out a braking action, and the adjustment, i.e. the carrying out of an adjusting action to compensate for component tolerances and wear on the drum brake, in particular the brake shoes. The central component is a cam disk, which is segmented into the different work areas, i.e., a braking area for a system braking function and an adjusting area for an adjusting function. Since the cam disk continues to be repetitive, a stepping gear coupled with the cam disk is used to permit a spindle offset in the spread. The stepping gear permits the rotational movement of the cam disk to be divided into a locking section and into a switching section. Due to the repetitive behavior of the cam disk, each revolution of the cam disk may be easily found on the basis of the repeating profiling. This permits a secure setting of a defined air gap during the startup of the spreader device according to the invention. The adjusting function is carried out via the stepping gear. An electromechanical spreader device for a drum brake is thus specified on the basis of a cam drive, in which a functionality is achieved by superimposing a stepping gear, in which the functions of a service brake are made possible using a single drive, namely carrying out a braking action, and the function of a brake lining compensation, namely carrying out an adjusting action. Moreover, it is also achieved via the invention that the pitch of the cam disk, i.e., the cam lift, is cut almost in half compared to, for example, a recirculating ball screw under the same load. Correspondingly, an electromechanical spreader device is facilitated, in which lower moments and loads may be implemented with the same or improved functionality, so that the spreader device according to the invention may be constructed and manufactured, for example, with smaller dimensions.

The spreader device for a drum brake according to the invention can be freely selectable within broad, suitable parameters, according to the type, functionality, material, and dimensioning.

The spreader device can be designed in such a way that the cam disk is supported in a floating manner between the two actuating elements, the cam disk preferably being supported on the second actuating element connected to the stepping gear in a force-transmitting manner. In this way, the simultaneous actuation of the two actuating elements and thus the two brake shoes of the drum brake is made possible particularly easily in terms of construction and manufacturing. This applies, in particular, to the example of this refinement. In principle, however, other examples of the invention can have a floating support deviating therefrom are also conceivable. For example, a an example of the invention provides that the electromechanical spreader device as a whole is supported in a floating manner on a remaining part of the drum brake of the vehicle, for example via a housing of the electromechanical spreader device.

The cam disk can be connected to the output in a torque-transmitting manner with the aid of the actuating disk, preferably that the output includes an output spur gear, and the actuating disk includes a spur toothing which meshes with the output spur gear. The construction and manufacturing of the spreader device according to the invention is further simplified hereby. The torque transmission with the aid of the spur toothing is furthermore a proven as well as robust and long-standing technique for transmitting torque.

The stepping gear can be designed as a Geneva drive, preferably including a five-pointed star wheel, which is in engagement with the actuating disk in the engagement rotation angle area of the cam disk. In this way, the stepping gear is implemented via a simple technical design which has already been proven in many applications. For example, the Geneva drive includes a five-pointed star wheel. Alternatively, Geneva drives having more or fewer steps, i.e., including an n-pointed star wheel, are also conceivable, n being a natural number not equal to zero and five. Alternative stepping gears are also possible, such as the star wheel mechanism including multiple lock shoes. While this is more complex structurally, it also permits a better design of the two axes of the stepping gear. Reference is furthermore made purely by way of example to cam gears as an additional variant of the stepping gear.

The stepping gear can be connected in a force-transmitting manner to the corresponding second actuating element with the aid of a worm gear of the spreader device connected to the stepping gear in a torque-transmitting manner and a screw drive of the spreader device connected to the worm gear in a torque-transmitting manner. The force-transmitting connection according to the invention between the stepping gear, on the one hand, and the second actuating element, on the other hand, may be particularly easily implemented hereby in a highly space-saving manner in terms of construction and manufacturing. For example, a simple trapezoidal spindle without a ball bearing is sufficient here for the spindle design. A poorer efficiency by dispensing with the ball bearing is possible here if the adjusting action with the aid of the stepping gear, in relation to the cam disk, is in a segment other than the service brake function, i.e., the braking action, and there are no requirements imposed on a good efficiency from the transmission function. The screw drive is additionally reduced with the worm stage, so that, for example, a setting using low forces is possible even at a high spring pretensioning with the aid of the spring element. By reducing the screw drive with the worm stage, the adjustment, i.e. the adjusting action, may take place with the aid of only low forces even at a high spring pretensioning by the spring element.

The actuating plunger can include an actuating wheel which contacts the cam disk in a force-transmitting manner and is rotatably supported on a remaining part of the actuating plunger. The friction between the cam disk, on the one hand, and the actuating plunger, on the other hand, is significantly reduced in this way. For the design of the actuating wheel with respect to the problematic Hertzian contact stress thereof, variants of the actuating plunger are also conceivable which include more than one actuating wheel or also a concave actuating wheel, which is more advantageous in terms of the Hertzian contact stress. Accordingly, the term “actuating wheel” is to be broadly interpreted here, so that roll-off elements adapted to the aforementioned variants are also included therein.

The cam disk can have a depression in a circumferential contact surface with the actuating plunger for receiving the actuating plunger during a parking brake action of the spreader device, the depression preferably being arranged between a section of the contact surface designed as a braking area for carrying out the braking action and a section of the contact surface designed as an adjusting area and corresponding to the engagement rotation angle area for carrying out an adjusting action of the spreader device, the second actuating element being adjusted by the stepping gear in the direction of the brake shoe adjustable thereby during the adjusting action. The functionality of the spreader device according to the invention is additionally increased hereby, since not only the braking action and the adjusting action but also a parking brake action is made possible, The depression ensures that, during the parking brake action, the actuating plunger remains in the set position relative to the cam disk even in a de-energized state of the electric motor. The parking brake function is thus safely performed even in this de-energized state of the electric motor. While the actuating plunger is in the braking area, i.e. the system brake, and in the parking braking area, i.e. the parking brake function, of the cam disk, the stepping gear remains in a locked state and therefore, unlike in a switching state of the stepping gear, is not moved. The spring element serves the parking brake function as usual.

The spreader device can be designed in such a way that the adjusting action is carried out only when the actuating plunger is in contact with the adjusting area. In this way, a strict separation of the individual functionalities of the spreader device according to the invention is implemented according to the present refinement, so that a defined construction and manufacturing dimensioning of the individual functions, and thus of the areas of the cam disk corresponding thereto as well as the individual gears, is made possible.

A cam lift of the cam disk for actuating the actuating plunger can be designed only to overcome a predefined air gap and an elasticity of the drum brake. Since a provision of a wear path of, for example, two times 6 mm is dispensed with, due to the design of the electromechanical spreader device according to the invention, the cam lift of the cam disk may be kept very slight compared to the prior art. This comparatively slight cam lift results in smaller moments at the electric motor, as well as of the spur wheel section and the cam disk, and thus permits a significant reduction in the size of the spreader device according to the invention according to the present refinement, so that lower strengths of the individual components of the spreader device according to the invention are therefore also necessary.

The spreader device can be designed in such a way that, when carrying out the adjusting action, an adjusting lift of the second actuating element is smaller by a factor of at least 5, preferably by a factor greater than 10, compared to a cam lift of the cam disk for actuating the actuating plunger when carrying out the braking action, in relation to a full revolution of the cam disk in each case. The adjusting action is carried out via the stepping gear, for example on the aforementioned screw drive. For each completed step, i.e., for each complete revolution of the cam disk, the adjusting lift is much smaller, namely by a factor of at least 5, than the cam lift during the braking function, i.e., when carrying out the braking action. In each case, the cam lift thus ensures that the full air gap and the full elasticity of the drum brake may be carried out with the aid of a single cam lift. The adjustment lift results only in a small offset in the spreading apart of the two brake shoes with the aid of the two actuating elements of the spreader device according to the invention.

The spring element can be designed in such a way that a spring pretensioning of the spring element may compensate for a thermal expansion of the spreader device of at least 1 mm when carrying out a parking brake action, and it is greater than a predefined maximum braking force when carrying out the braking action and the parking brake action, the maximum braking force preferably being greater than or equal to 5 kN when carrying out the parking brake action. The spring pretensioning is selected hereby in such a way that the spring element may compensate for a thermal longitudinal expansion within the spreader element of at least 1 mm without the spreading force dropping below a minimum amount, i.e., the parking brake function has sufficient braking force in each case, even if the spreader element cools down and contracts. Since the spring pretensioning is selected to be so high here that it is higher than needed for the service brake function, i.e. the braking action, this ensures that the slight cam lift of the cam disk is sufficient to apply the maximum braking force.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of the electromechanical spreader device according to the invention in a perspective representation;

FIG. 2 shows the example in a top view;

FIG. 3 shows the example in a first partial top view for better visibility of the stepping gear;

FIG. 4 shows the example in a second partial top view for better visibility of the support of the cam disk;

FIG. 5 shows a representation of the segmentation of the cam disk into the braking area, the depression for the parking brake function, and the adjusting area;

FIG. 6 shows a representation of the superimposition of the offset of the screw drive by the cam disk radius;

FIG. 7 shows a representation of the braking force depending on the rotational position of the cam disk; and

FIG. 8 shows a representation of the torque of the cam disk depending on the rotational position of the cam disk.

### DETAILED DESCRIPTION

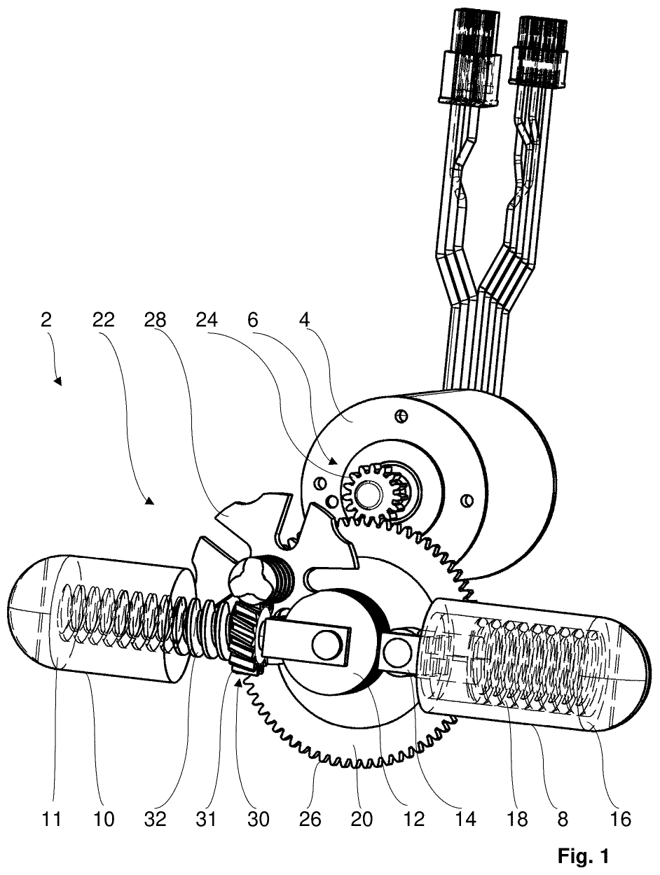

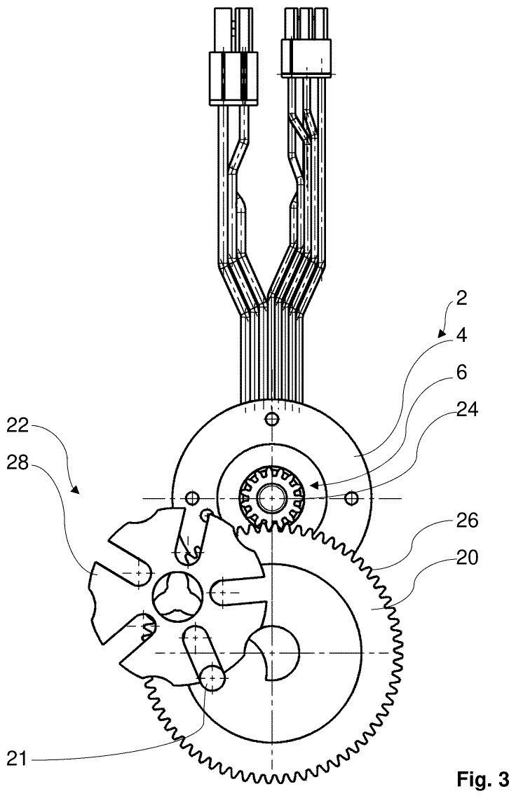

An example of the electromechanical spreader device according to the invention for a drum brake of a vehicle is illustrated purely as an example in FIGS. 1 through 8 for the purpose of spreading apart two brake shoes of the drum brake as needed. The drum brake, including the two brake shoes, and the vehicle are not illustrated here.

Electromagnetic spreader device 2 comprises an electric motor 4, which is controllable with the aid of a controller of the vehicle and includes an output 6, a cam disk 12 which is connected to output 6 in a torque-transmitting manner and is arranged between two actuating elements 8, 10 situated opposite each other, each connected to one of the brake shoes in a force-transmitting manner for simultaneously actuating the two actuating elements 8, 10 during a braking action of spreader device 2, a first of the two actuating elements 8 having a spring element 18 arranged between an actuating plunger 14 of this first actuating element 8, which contacts cam disk 12 in a force-transmitting manner, and an abutment 16 of this first actuating element 8.

According to the invention, cam disk 12 is connected to an actuating disk 20 of a stepping gear 22 in a torque-transmitting manner, stepping gear 22 being connected to a second of the two actuating elements 10 in a force-transmitting manner in such a way that this second actuating element 10 is adjustable via a rotation of cam disk 12 in an engagement rotation angle area, in which actuating disk 20 is in a torque-transmitting engagement with a remaining part of stepping gear 22 in a first direction of rotation toward the brake shoe, which is movable therewith, and is adjustable away from this brake shoe in the opposite direction in the engagement rotation angle area via a rotation of cam disk 12 in a second direction of rotation opposed to the first direction of rotation.

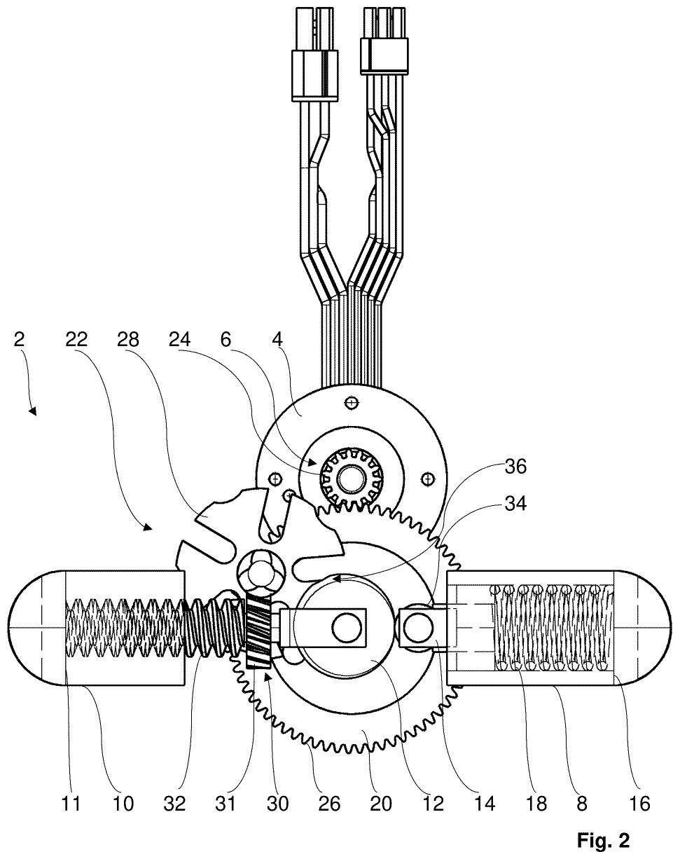

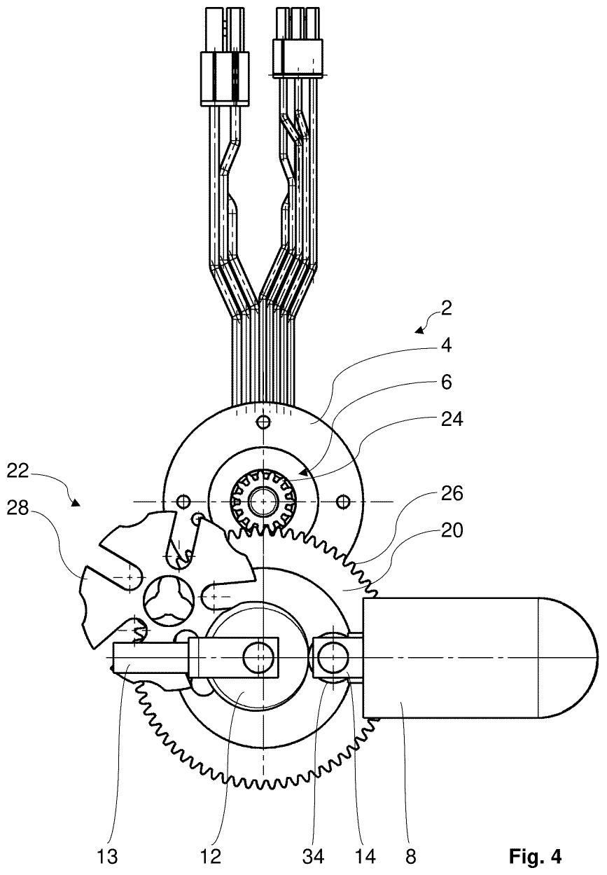

Spreader device 2 is furthermore designed in such a way that cam disk 12 is supported in a floating manner between the two actuating elements 8, 10, cam disk 12 being supported on second actuating element 10, which is connected to stepping gear 22 in a force-transmitting manner. Also see, in particular, FIGS. 2 and 4, from which the support of cam disk 12 on second actuating element 10 is apparent in greater detail in connection with the following remarks. Further examples of the invention can have a floating support deviating therefrom are also conceivable. For example, a an example of the invention, can provide that the electromechanical spreader device as a whole is supported in a floating manner on a remaining part of the drum brake of the vehicle, for example via a housing of the electromechanical spreader device.

In the present example, cam disk 12 is connected to output 6 in a torque-transmitting manner via actuating disk 20, output 6 including an output spur gear 24, and actuating disk 20 including a spur toothing 26 which meshes with output spur gear 24.

As is apparent from FIGS. 1 through 4, stepping gear 22 is designed here as a Geneva drive, actuating disk 20 being in engagement with a five-pointed star wheel 28 of stepping gear 22 in the engagement rotation angle area of cam disk 12.

Stepping gear 22 is also connected in a force-transmitting manner to second actuating element 10 corresponding thereto via a worm gear 30 of spreader device 2 connected in a torque-transmitting manner to stepping gear 22 and to a screw drive 32 of spreader device 2 connected in a torque-transmitting manner to worm gear 30. Cam disk 12 is supported in a floating manner on second actuating element 10 via a bearing bolt 13, which is rotatably supported on cam disk 12, bearing bolt 13 protruding through a hollow spur wheel 31 of worm gear 30 and projecting into a blind hole of screw drive 32, and being supported indirectly on second actuating element 10 via screw drive 32. Alternatively, however, it would also be conceivable for the bearing bolt to protrude through the hollow spur wheel of the worm gear and a hollow screw drive and be supported directly on an abutment, for example an abutment 11 of second actuating element 10. In the first case mentioned, abutment 11 is not necessary.

Actuating plunger 14 here includes an actuating wheel 34, which contacts cam disk 12 in a force-transmitting manner and is rotatably supported on a remaining part of actuating plunger 14, for the purpose of reducing friction.

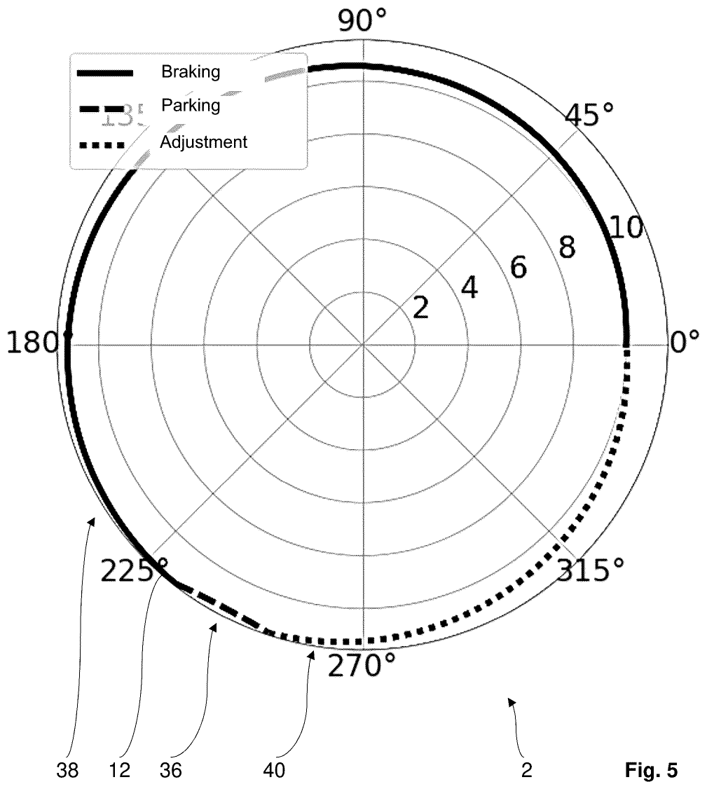

Cam disk 12 has a depression 36 in a circumferential contact surface with actuating plunger 14 for receiving actuating wheel 34 of actuating plunger 14 during a parking brake action of spreader device 2, namely in such a way that depression 36 is arranged between a section of the contact surface designed as a braking area 38 for carrying out the braking action and a corresponding section of the contact surface designed as an adjusting area 40 and corresponding to the engagement rotation angle area for carrying out an adjusting action of spreader device 2, the second actuating element 10 being adjusted via stepping gear 22 in the direction of the brake shoe, which is movable thereby, during the adjusting action. Aforementioned areas 38, 40, and, in particular, depression 36, are clearly apparent in FIG. 5. As is apparent in FIG. 5, the braking area extends from 0° to approximately 233°, depression 36 extends from approximately 233° to approximately 252°, and the adjusting area extends from approximately 252° to 0°.

Spreader device 2 is furthermore designed in such a way that the adjusting action is carried out only when actuating plunger 14 is in contact with adjusting area 40.

Cam disk 12 is also designed in such a way that a cam lift of cam disk 12 for actuating actuating plunger 14 is designed only to overcome a predefined air gap and an elasticity of the drum brake. An air gap is understood to be the free travel of spreader device 2 while no braking action is yet present, since the brake shoes do not yet rest against the drum of the drum brake.

Spreader device 2 here is designed in such a way that, when carrying out the adjusting action, an adjusting lift of second actuating element 10 is smaller by a factor of 12 compared to a cam lift of cam disk 12 for actuating actuating plunger 14 when carrying out the braking action, in relation to a full revolution of cam disk 12 in each case.

Finally, spring element 18 in the present example can be designed in such a way that a spring pretensioning of spring element 18 may compensate for a thermal expansion of spreader device 2 of at least 1 mm when carrying out a parking brake action, and it is greater than a predefined maximum braking force when carrying out the braking action and the parking brake action, the maximum braking force being greater than or equal to 5 kN when carrying out the parking brake action.

The functionality of the electromechanical device according to the invention is explained in greater detail below according to the present example, based on FIGS. 1 through 8.

Starting from electric motor 4, a torque is transformed via the spur wheel section, namely output 6 and actuating disk 20. On this basis, the torque is transmitted to cam disk 12, which is connected to actuating disk 20 in a torque-transmitting manner. Cam disk 12 is segmented for the functions of braking, parking, and adjustment, as is apparent in FIG. 5. In FIG. 5, a circumferential contour of cam disk 12 is shown by the thick line, resolved according to the angular degrees. Braking area 38 for the braking action is illustrated by the solid thick line, depression 36 for the parking brake function is illustrated by the dashed thick line, and adjusting area 40 for the adjusting function is illustrated by the dotted thick line. Numbers 2, 4, 6, 8, and 10 arranged radially in FIG. 5 stand for 2, 4, 6, 8, and 10π and represent the number of revolutions, one revolution corresponding to 2π. If cam disk 12 moves within braking area 38, i.e., if actuating plunger 14 rests against cam disk 12 in braking area 38, the positive change in radius of cam disk 12 acts directly upon the spreading of the drum brake via actuating wheel 34 and pretensioned spring element 18. The pretensioning of spring element 18 is selected in such a way that the maximum spreading force for the drum brake is below the pretensioning. As a result, spring element 18 is not compressed by the applied spreading force while braking during the braking action. The use of pretensioned spring element 18 is the general prior art when constructing parking brakes and is used to compensate for expansions, primarily the thermal expansion, of a tensioned parking brake. In the case of the present example, the same also applies to the parking brake function during the parking brake action, i.e., when actuating plunger 14 is in depression 36. The tensioning force exceeds the pretensioning of spring element 18 and compresses spring element 18 for the purpose of expansion compensation.

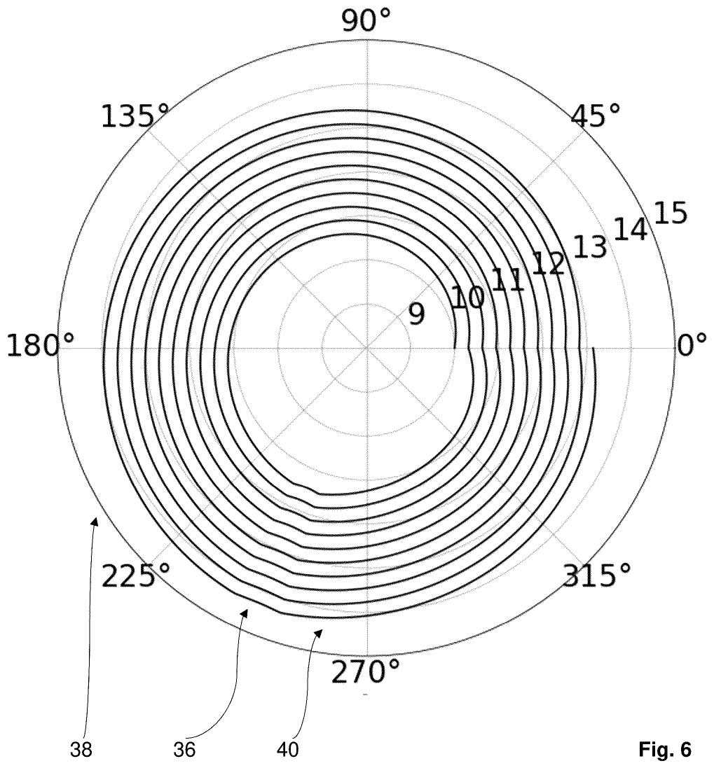

If cam disk 12 moves within adjusting area 40, i.e., if actuating plunger 14 is within adjusting area 40, stepping gear 22 is coupled in via an entrainer 21 of actuating disk 20. Worm gear 30 now moves together with the rotation of cam disk 12 and drives screw drive 32. Screw drive 32 is coupled in such that the adjustment lift of screw drive 32 results as the cam disk radius decreases. The adjustment lift here is significantly smaller than the cam lift of cam disk 12. A smaller offset of screw drive 32 results hereby for each revolution of cam disk 12. This offset is needed to establish a compensation for the wear of the brake linings connected to actuating elements 8, 10 in a force-transmitting manner. A superimposition of the cam disk radius onto the offset by screw drive 32 is illustrated in FIG. 6. As is clearly apparent from a combined examination of FIGS. 5 and 6, the adjustment lift via screw drive 32 illustrated by a thick solid line in FIG. 6 is much smaller for each revolution of cam disk 12 than the cam lift of cam disk 12 illustrated in FIG. 5.

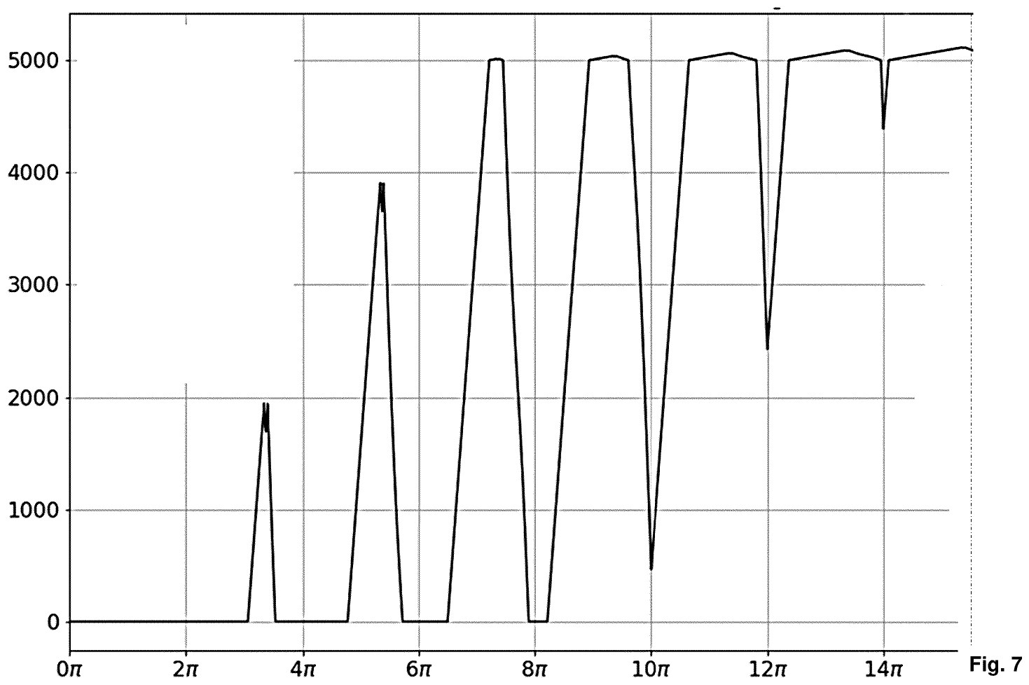

The step-by-step adjustment with the aid of stepping gear 22 permits a countable guidance of spreader device 2. The counting makes it possible to guide the adjustment in such a way that a minimal air gap, i.e. a minimal free travel of the spreader device, is always present. Accordingly, this free travel may be kept as short as possible, so that the response times for braking during the braking action or the parking brake action are short. The counting also permits a secure opening of the brake without the air gap, i.e. the free travel, opening too wide, which is as a whole problematic for the braking. Also see FIG. 7, in which the braking force is given in N, depending on the rotational position of the cam disk. The ideal adjustment is shown there in the range from 8π to 10π, i.e., around 4 to 5 revolutions. No formation of the braking force, or only to a limited extent, is seen in the range from 0π to 6π. In the range greater than 10π, it is apparent that the braking force is not fully decreased. In the latter case, the brake shoes would always rest, i.e. undesirably, against the drum, and thus grind. If the adjustment was carried out for the purpose of compensating for component tolerances and brake shoe wear, i.e., if cam disk 12 rotates, for example, four to five times completely in the first direction of rotation so that actuating element 10 was adjusted in the direction of the assigned brake shoe, braking area 38 for carrying out the braking action begins, for example, around 8π. Between 8π and 10π, each rotational position of cam disk 12 may be approached in a targeted manner for the purpose of carrying out a braking action or a parking brake action. If cam disk 12 continues to be rotated in this first direction, the braking action of the brake shoes intensifies, as is apparent in FIG. 7. Depression 36 beings at the end of braking area 38. With the aid of depression 36, the parking brake function may be carried out via the parking brake action. If actuating plunger 14 is in depression 36, the braking force moves only in the uppermost range, cam disk 12 as well as spring element 18 acting in a force-generating manner in this range. If cam disk 12 were to continue to be rotated in the aforementioned first direction of rotation, adjusting area 40 would again begin for carrying out a further adjusting action, if this is necessary. While carrying out the adjusting action, the braking force again decreases until stepping gear 22 is no longer coupled in via entrainer 21, and the adjusting action has ended. If cam disk 12 were to continue to be rotated in the aforementioned first direction of rotation, braking area 38 would again begin thereafter.

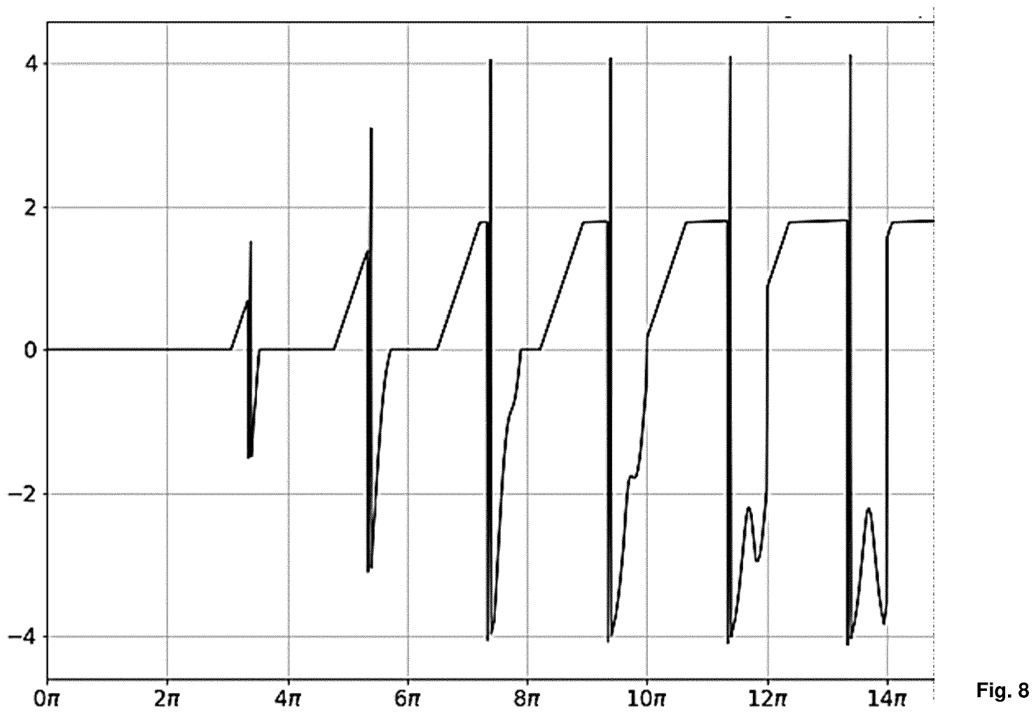

The torque curve of cam disk 12 for the functions of braking, adjusting, and parking is illustrated in FIG. 8, in which the torque of cam disk 12 is shown in Nm, depending on the rotational position of the cam disk. This shows that a reduction in the torque could be achieved, as described above, and calculated to approximately 2 Nm for this illustrated model, by the advantageous use of cam disk 12 to reduce the pitch of the cam lift. The result of this is that the input gear ratio corresponding to cam disk 12 is reduced, and the dynamic properties of spreader device 2 are thus also significantly improved compared to the prior art. A maximum spreading force greater than 5 kN and a compensation of approximately 1 mm thermal expansion are necessary for the parking function, so that sufficient braking force is always present for the parking brake action. In addition, depression 36 of cam disk 12 makes it possible for the parking brake function to be given even in a de-energized electric motor 4. Actuating plunger 14 is held securely in depression 36 even if electric motor 4 is de-energized, which is explained in greater detail below. Torque peaks which briefly exceed 2 Nm exist in FIG. 8. However, this is only temporarily the case when cam disk 12 continues to be rotated starting from the parking brake action, i.e., starting from depression 36, for example to reach adjusting area 40 for the purpose of carrying out an adjusting action. Actuating plunger 14 must be moved out of depression 36, which briefly results in a higher torque. However, this load is only of short duration and is not present at all during normal operation, i.e., when carrying out the braking action.

For the parking function, i.e., the parking brake function, depression 36, within which actuating wheel 34 of actuating plunger 14 may rest even when electric motor 4 is de-energized, is situated on cam disk 12. To build up the tensioning force for the parking function, cam disk 12 is rotated multiple times, so that, upon the interaction of stepping gear 22 and coupled screw drive 32, multiple adjusting lifts are carried out, which tension pretensioned spring element 18 by approximately 1 mm to provide the necessary expansion compensation. By counting the steps of stepping gear 22, the measurement of the expansion compensation in tensioned spring element 18 may be reliably achieved, since the adjusting lift for each step and the number of steps of stepping gear 22 are known. if actuating plunger 14 is in depression 36, cam disk 12 is de-energized in this rotational position. The rotational position of depression 36 is visible in the torque curve based on the torque peaks, i.e., the current peaks in the motor current of electric motor 4. Alternatively to the Geneva drive having five steps illustrated here, alternatives having more or fewer steps are also conceivable in further examples of the invention. Alternative stepping gears are also possible, such as the star wheel mechanism including multiple lock shoes. While this is more complex structurally, it also permits a better design of the axes of the stepping gear. Cam gears are also conceivable as a further variant of the stepping gear. The aforementioned stepping gear designs are mentioned purely as examples. For the design of the actuating plunger, in particular the actuating wheel, due to the problematic Hertzian contact stress thereof, variants are also conceivable which include more than one actuating wheel or a concave actuating wheel, which is more advantageous in terms of the Hertzian contact stress. Accordingly, the term “actuating wheel” is to be very broadly interpreted, as already discussed in the introduction of the background information.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electromagnetic spreader device for a drum brake of a vehicle for spreading apart two brake shoes of the drum brake as needed, the electromagnetic spreader device comprising:
an electric motor, which is controllable with the aid of a controller of the vehicle and includes an output; and
a cam disk connected to the output in a torque-transmitting manner and is arranged between two actuating elements arranged opposite each other, each of the two actuating elements being connected to one of the brake shoes in a force-transmitting manner for substantially simultaneously actuating the two actuating elements during a braking action of the spreader device, a first of the two actuating elements having a spring arranged between an actuating plunger of this first actuating element, which contacts the cam disk in a force-transmitting manner, and an abutment of the first actuating element,
wherein the cam disk is connected to an actuating disk of a stepping gear in a torque-transmitting manner, and
wherein the stepping gear is connected to a second of the two actuating elements in a force-transmitting manner such that the second actuating element is adjustable via a rotation of cam disk in an engagement rotation angle area, in which the actuating disk is in a torque-transmitting engagement with a remaining part of the stepping gear in a first direction of rotation toward the brake shoe, which is movable therewith, and is adjustable away from this brake shoe in an opposite direction in the engagement rotation angle area via a rotation of the cam disk in a second direction of rotation opposed to the first direction of rotation.

2. The electromechanical spreader device according to claim 1, wherein the spreader device is designed such that the cam disk is supported in a floating manner between the two actuating elements, or wherein the cam disk is supported on the second actuating element, which is connected to the stepping gear in a force-transmitting manner.

3. The electromechanical spreader device according to claim 1, wherein the cam disk is connected to the output in a torque-transmitting manner via the actuating disk, or wherein the output includes an output spur gear, and the actuating disk includes a spur toothing which meshes with the output spur gear.

4. The electromechanical spreader device according to claim 1, wherein the stepping gear is a Geneva drive, including a five-pointed star wheel, which is in engagement with the actuating disk in the engagement rotation angle area of the cam disk.

5. The electromechanical spreader device according to claim 1, wherein the stepping gear is connected in a force-transmitting manner to the second actuating element corresponding thereto via a worm gear of the spreader device connected in a torque-transmitting manner to the stepping gear and a screw drive of the spreader device is connected in a torque-transmitting manner to the worm gear.

6. The electromechanical spreader device according to claim 1, wherein the actuating plunger includes an actuating wheel, which contacts the cam disk in a force-transmitting manner and is rotatably supported on a remaining part of the actuating plunger.

7. The electromechanical spreader device according to claim 1, wherein the cam disk has a depression in a circumferential contact surface with the actuating plunger for receiving the actuating plunger during a parking brake action of the spreader device, wherein the depression is arranged between a section of the contact surface designed as a braking area for carrying out the braking action and a section of the contact surface designed as an adjustment area and corresponding to the engagement rotation angle area for carrying out an adjusting action of the spreader device, and wherein the second actuating element is adjusted via the stepping gear in the direction of the brake shoe movable thereby during the adjusting action.

8. The electromechanical spreader device according to claim 7, wherein the spreader device is designed such that the adjusting action is carried out only when the actuating plunger is in contact with the adjusting area.

9. The electromechanical spreader device according to claim 1, wherein the cam disk is designed in such a way that a cam lift of the cam disk for actuating the actuating plunger is designed only to overcome a predefined air gap and an elasticity of the drum brake.

10. The electromechanical spreader device according to claim 1, wherein the spreader device is designed such that, when carrying out the adjusting action, an adjusting lift of the second actuating element is smaller by a factor of at least 5 or by a factor greater than 10, compared to a cam lift of the cam disk for actuating the actuating plunger when carrying out the braking action, in relation to a full revolution of the cam disk in each case.

11. The electromechanical spreader device according to claim 1, wherein the spring element is designed such that a spring pretensioning of the spring element compensates for a thermal expansion of the spreader device of at least 1 mm when carrying out a parking brake action, and it is greater than a predefined maximum braking force when carrying out the braking action and the parking brake action, and wherein the maximum braking force is greater than or equal to 5 kN when carrying out the parking brake action.
